(19) United States
(12) Patent Application Publication
(10) Pub. No.: US 2008/0155159 A1
(43) Pub. Date: Jun. 26, 2008

(54) Integrated communication and information processing system

(76) Inventors: Mario A. Rivas, Austin, TX (US); Terry Lynn Cole, Austin, TX (US)

Correspondence Address: HAMILTON & TERRILE. LLP, P.O. BOX 203518, AUSTIN, TX, 78720, US

(21) Appl. No.: 11/615,352

(22) Filed: Dec. 22, 2006

(51) Int. Cl. G06F 13/14

(52) U.S. Cl. 710/305

(57) ABSTRACT

An apparatus and method is disclosed for integrating an information processing system and a portable communication device. A first information processing system is coupled to a second information processing system through a connection such as a dock, cable, or wireless link. Once coupled, an interface connection manager is implemented to enable the second system to perform processing operations using the first system's network connections and peripherals and vice-versa. The interface connection manager then establishes a communications channel between the coupled systems to a third information processing system, typically through a physical or wireless network connection. The interface connection manager similarly enables the first system to perform authentication operations by accessing an authentication module implemented in the second system. When physically coupled, a power management module manages the respective power states of the two systems to provide power from the first system's power source to the second system.

### BACKGROUND OF THE INVENTION

1. Field of the Invention

Embodiments of the invention relate generally to information processing and communication systems. More specifically, embodiments of the invention provide a method and apparatus for integrating an information processing system and a portable communication device.

2. Description of the Related Art

Advances in microprocessor design and manufacturing have led to the evolution of powerful computing platforms with small form factors, modest power consumption, and low heat dissipation. These platforms have been adopted for use in a wide variety of wireless-enabled mobile devices that include cell phones, smartphones, laptops tablets PCs, PDAs, and special purpose devices such as bar code readers. While many of these devices share similar operational, processing and communications capabilities, no single device addresses all needs. As a result, there has been a steady proliferation of mobile, wirelessly-enabled devices, with the user often carrying multiple devices, each of which may serve a specific purpose and use a different means of communication.

It is common for a mobile user to travel with a laptop computer, a personal digital assistant (PDA), cell phone, secure ID token, audio/video (A/V) media player, digital camera, etc. The individual functionality of each of these devices can be combined into the functionality of another, but usually at the cost of reduced capabilities. For example, current laptop computers provide processing, storage, display and communications capacity that rivals desktop units, all in a reasonably lightweight package. However, unless they are placed in hibernation mode, boot-up times can take as long as stationary systems. Many PDAs have significant data processing power, but their reduced form factors restrict the size of their display screens and user input methods are restricted to miniaturized keyboards or use of stylus gestures. Limited PDA features, along with equally limited digital camera and A/V media playing capabilities are now being converged into a smartphone, but their even smaller form factor, weight, battery life and usage models places further restrictions on their computing capabilities, display screens, input methods, and storage capacity. Smartphones, PDAs, dedicated A/V media players, digital cameras, and other small form factor mobile devices are designed to be lightweight, highly transportable, and convenient to use. However, there are times when a mobile user would prefer to have expanded I/O capabilities, such as a full size keyboard or larger screen. Laptops can generally provide such I/O capabilities to these devices through physical connections such as universal serial bus (USB), IEEE1394 (Firewire), PCI Express, HyperTransport, and increasingly through wireless connections such as Bluetooth and Ultra Wideband (UWB). While these connectivity options provide desired functionality, they take time to configure and there are times when it is inconvenient, or takes too long, for a user to power-up their laptop.

Furthermore, users increasingly want to be able to connect their devices by all methods available. For example, they may want their laptop to have cellular (e.g., GPRS or EDGE) capabilities or their digital camera and cell phone to have IEEE 802.11 wireless connectivity. While it is possible to include these kinds of extended capabilities, they come at the price of increased cost, size, battery capacity and weight. For example, many current laptops come equipped with Ethernet ports for physical local area network (LAN) connectivity, transceivers supporting variants of the IEEE 802.11 for wireless LAN (WLAN) connectivity, and Bluetooth transceivers for personal area network (PAN) connectivity. Currently, few cell phones and PDAs are equipped for WiFi communications. Instead, they are more typically implemented with data communication capabilities based on current and emerging voice standards. For instance, a 2.5G cell phone may use the global system for mobile communications (GSM) for voice communications and the companion general packet radio services (GPRS). A 2.75G smartphone may use GSM for voice and enhanced data rates for GSM evolution (EDGE) for data communications. A 3G smartphone may implement universal mobile telecommunications system (UMTS) or wideband code division multiple access (W-CDMA). Furthermore, additional telecommunications standards such as ultra wideband (UWB), evolution-data optimized (EVDO), IEEE 802.16 (WiMAX), wireless broadband (WiBro), high-speed downlink packet access (HSDPA), and high-speed uplink packet access (HSUPA) are in the process of being implemented with fourth generation (4G) technologies on the horizon. Each of these protocols has its merits, but no single device can support them all. While it is possible to add support for additional protocols to a device, each addition comes at the price of increased cost, size, battery capacity and weight. Furthermore, competing carriers support different protocols and their coverage is not universal, creating difficulties for mobile device manufacturers and users alike.

It would be desirable for a user to be able to use the mobile device and communications technology best suited and available for a given set of circumstances, yet still be able to easily utilize the aggregate capabilities of all the mobile devices at their disposal. As an example, a user may want to use their smartphone as the source of computing power, but also access their laptop computer's WiFi connectivity, full-size keyboard and large display without rebooting, restarting, or fully powering-up the laptop or using a cable connection. One approach is to give the user the ability to dock their smartphone in their laptop and use the laptop's as extended peripherals for the smartphone. Once the smartphone is docked, the laptop would run in a low power state while powering its peripherals as well as using its power source to power the smart phone and recharge its battery. However, this ability does not currently exist.

### SUMMARY OF THE INVENTION

An apparatus and method is disclosed for integrating an information processing system and a portable communication device. In various embodiments of the invention, a first information processing system is coupled to a second information processing system. Once coupled, the systems comprise processing logic capable of establishing a communications channel between themselves and a communications channel to a third information processing system, typically through a physical or wireless network connection. In these embodiments, an interface connection bus is implemented to enable a plurality of interface connections between the two systems. In various embodiments, an interface connection manager enables the second information system to perform processing operations using the first information processing system's network connections and peripherals. In these embodiments, the interface connection manager likewise enables the first information system to perform processing operations using the second information processing system's network connections and peripherals. In other embodiments, the interface connection manager enables the first information processing system to access an authentication module implemented in the second information processing system. Once accessed, the authentication performs authentication operations to authenticate users of the first information processing system.

In one embodiment, the first information processing system is coupled to the second through a physical connection such as a universal serial bus (USB) connection. In another embodiment, the first information processing system is coupled to the second through a wireless connection such as a Bluetooth or IEEE 802.11 (WiFi) connection. In other embodiments, the first information processing system is coupled to the second through a physical docking connection. In one embodiment, the dock is a receptacle whose form factor matches a predetermined mobile device. In another embodiment, the receptacle dock is universal and implemented to accept adapters implemented to adapt predetermined mobile devices to the universal dock. In yet another embodiment, the dock is a PCMCIA or ExpressCard slot.

In different embodiments, a power management module is implemented to manage the respective power states of the first and second information processing systems. Once coupled, the power management module is capable of assessing the respective operational capabilities and the current operating status of the two systems. In one embodiment, the power management module manages the respective power states of the two systems to provide power to the second information processing system from the first information processing system's power source. In another embodiment, the power management module manages the power states of the two systems to recharge the second information processing system's battery from the first information processing system's power source.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized block diagram illustrating an information processing system coupled to a mobile device in accordance with an embodiment of the invention;

FIGS. 2a-b are a generalized flowchart illustrating an information processing system coupled to a mobile device in accordance with an embodiment of the invention;

FIG. 3 is a generalized illustration of an information processing system coupled to a mobile device in accordance with an embodiment of the invention;

FIG. 4 is a generalized illustration of an information processing system coupled to a mobile device through a plurality of docking connections in accordance with an embodiment of the invention;

FIG. 5 is a generalized illustration of an information processing system enabled for coupling to a plurality of mobile devices through the implementation of a docking adapter in accordance with an embodiment of the invention; and

FIG. 6 is a generalized illustration of an information processing system enabled for coupling to a plurality of mobile devices comprising an authentication module as implemented in accordance with an embodiment of the invention.

### DETAILED DESCRIPTION

An apparatus and method is provided for integrating an information processing system and a portable communication device. A first information processing system is coupled to a second information processing system through a connection such as a dock, cable, or wireless link. Once coupled, the systems establish a communications channel between themselves and a communications channel to a third information processing system, typically through a physical or wireless network connection. An interface connection manager enables the second information system to perform processing operations using the first information processing system's network connections and peripherals and vice-versa. The interface connection manager similarly enables the first information processing system to access an authentication module implemented in the second information processing system. Once accessed, the authentication module performs authentication operations to authenticate users of the first information processing system. When physically coupled, a power management module manages the respective power states of the two systems to provide power to the second information processing system from the first information processing system's power source.

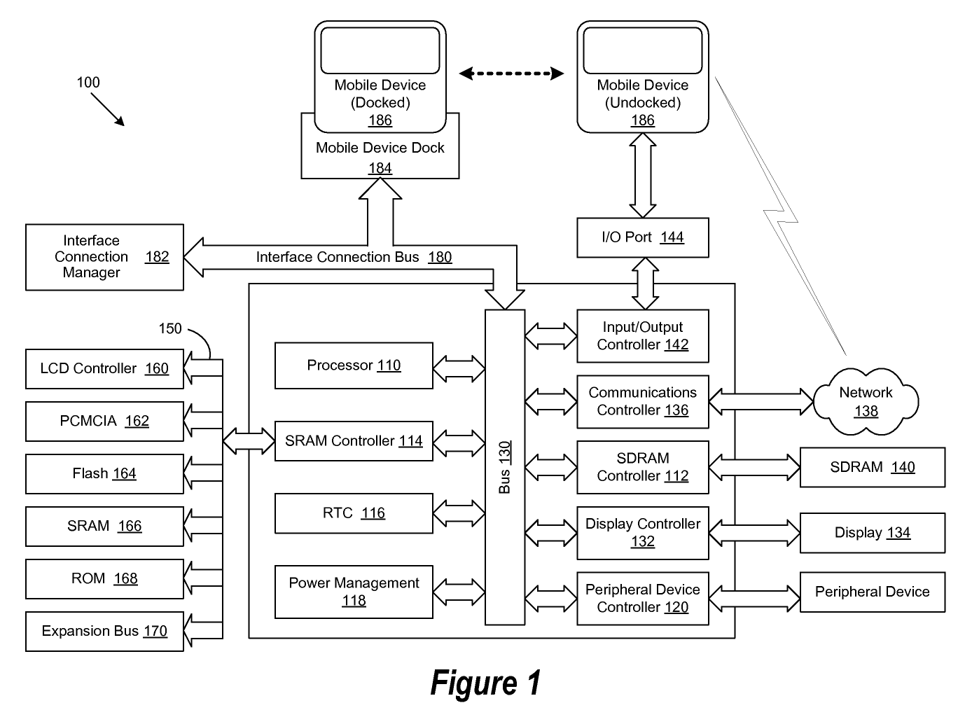

FIG. 1 is a block diagram illustrating an information processing system 100 as coupled to a mobile device in accordance with an embodiment of the invention. System 100 includes a processor 110, a synchronous dynamic random access memory (SDRAM) controller 112, a static random access memory (SRAM) controller 114, a real time clock 116, a power management module 118, display controller 132, communications controller 136, input/output (I/O) controller 142, and a peripheral device controller 120, all interconnected via bus 130.

Interface connection bus 180 couples interface connection manager 182 and mobile device dock 184, to bus 130. In various embodiments of the invention, docked mobile device 186 is physically coupled to interface connection bus 180 via mobile device dock 184. In one embodiment, the mobile device dock 184 comprises a PCMCIA or ExpressCard slot. In other embodiments of the invention, undocked mobile device 186 is physically coupled to interface connection bus 180 via a cable connection to I/O port 144 and I/O controller 142. In one embodiment, the physical coupling is over a universal serial bus (USB) connection. In another embodiment, the physical coupling is over an IEEE 1394 (Firewire) connection. In still other embodiments of the invention, undocked mobile device 186 is wirelessly coupled to interface connection bus 180 via a wireless network connection to network 138. Those of skill in the art will realize that sharing of graphic files and information types may require the implementation of multiple buses. As such, the buses illustrated herein should be considered only as a high level depiction and not meant to be construed as comprehensive or definitive.

In an embodiment of the invention, interface connection bus 180 is operable to enable a plurality of interface connections between docked mobile device 186 and information processing system 100. In one embodiment, interface connection manager 182 is operable to enable docked mobile device 186 to perform information processing operations while connected to at least one peripheral device coupled to peripheral device controller 120. In another embodiment interface connection manager 182 is operable to enable docked mobile device 186 to connect to display controller 132 to generate an image on display 134. In another embodiment, interface connection manager 182 is operable to enable docked mobile device 186 to connect to communications controller 136 to establish a network connection with network 138.

In different embodiments, network 138 may comprise a local area network (LAN) such as an Ethernet network or a wide area network (WAN) such as the Internet. Likewise, network 138 may also comprise a wireless local area network (WLAN) such as a WLAN based on a variant of IEEE standard 802.11, or a wireless wide area network (WWAN) such as a WWAN based on enhanced data rates for GSM evolution (EDGE), wideband code division multiple access (W-CDMA), evolution-data optimized (EVDO), IEEE 802.16 (WiMAX), wireless broadband (WiBro), high-speed downlink packet access (HSDPA), and high-speed uplink packet access (HSUPA). Similarly, network 138 may comprise a personal area network such as Bluetooth or ultra wideband (UWB), or any combination of telecommunication technologies and protocols operable to establish a connection between two information processing systems for the exchange of information. In another embodiment, interface connection manager 182 is operable to enable information processing system 100 to physically couple with docked mobile device 186 via interface connection bus 180 and mobile device dock 184. Once coupled, the interface connection manager is operable to establish a network connection utilizing the docked mobile device's communications capabilities.

In some embodiments, power management module 118 is operable to manage the power states of information processing system 100 and the docked mobile device 186 when they are physically coupled via the interface connection bus 180. In one embodiment, power management module 118 is operable to provide power from information processing system 100 to docked mobile device 186 when they are physically coupled via the interface connection bus 180. In another embodiment, power management module 118 is operable to manage the power state of the docked mobile device 186 to a predetermined power state operable to recharge the docked mobile device's battery. In selected embodiments, power management module 118 is operable to manage the power state of the mobile device 186 over a cable connection (e.g., USB) to a predetermined power state operable to recharge the docked mobile device's battery.

SDRAM controller 112 is coupled to SDRAM 140. SRAM controller 114 is coupled to a static bus 150. The static bus 150 is a general purpose bus which includes a plurality of control signal paths, including a plurality of general purpose I/O signal paths. Some or all of the control signal paths and the general purpose I/O signal paths may be used depending on the type of device with which the SDRAM controller 112 is communicating.

Static bus 150 is also coupled to one or more static bus devices such as, e.g., an LCD controller 160, a personal computer memory card international association (PCMCIA) device 162, a flash memory device 164, SRAM 166, read only memory (ROM) 168 and an expansion bus 170. The SRAM controller 114 functions as a general purpose bus controller and may communicate with any one of a plurality of static bus devices. For example, when SRAM controller 114 is communicating with the SRAM 166, then SRAM controller 114 functions as an SRAM controller. When SRAM controller 114 is communicating with a PCMCIA device 162, the SRAM controller 114 functions as a PCMCIA controller.

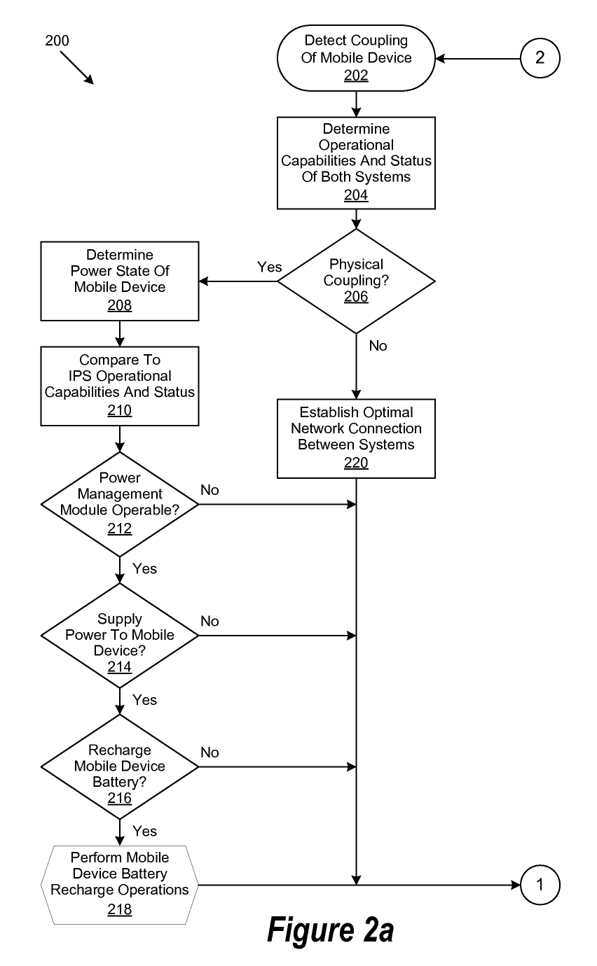

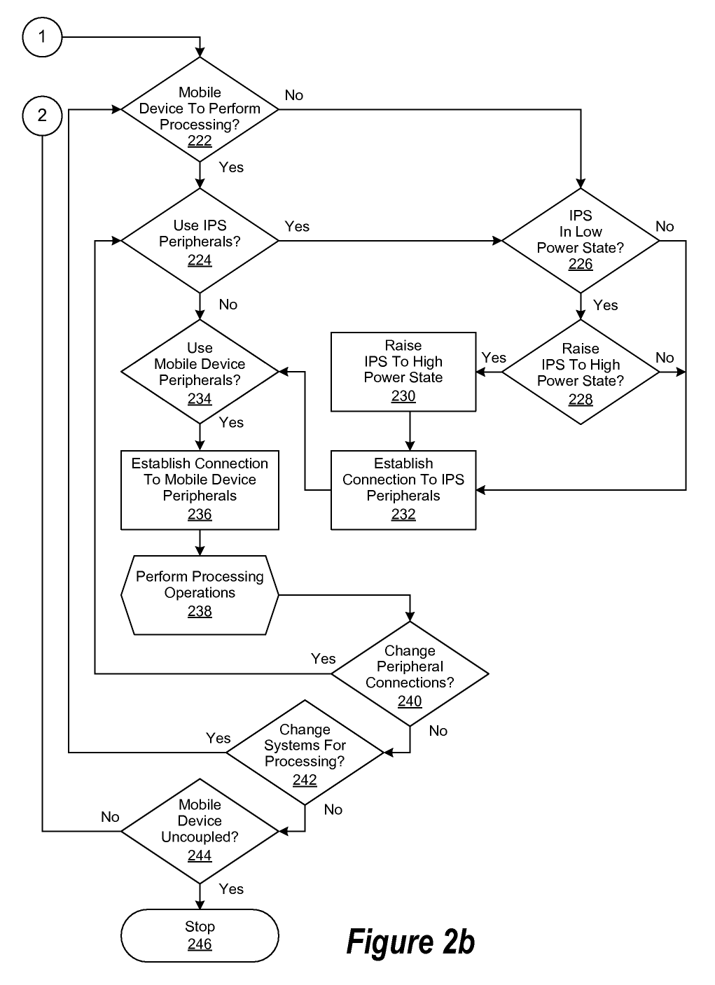

FIGS. 2a-b are generalized flowcharts illustrating an information processing system 200 as coupled to a mobile device in accordance with an embodiment of the invention. In selected embodiments, coupling of a mobile device to an information processing system is detected by an interface connection manager in step 202. Once detected, the interface connection manager determines the operational capabilities and current operating status of both the coupled mobile device and the information processing system in step 204.

The interface connection manager determines in step 206 whether the mobile device is physically coupled to the information processing system. If it is not, then the interface connection manager establishes the optimal network connection between the mobile device and the information processing system in step 220. In different embodiments, the network connection may be over a local area network (LAN) such as an Ethernet network or a wide area network (WAN) such as the Internet. Likewise, the network connection may be over a wireless local area network (WLAN) such as a WLAN based on a variant of IEEE standard 802.11, or a wireless wide area network (WWAN), such as a WWAN based on enhanced data rates for GSM evolution (EDGE), wideband code division multiple access (W-CDMA), evolution-data optimized (EVDO), IEEE 802.16 (WiMAX), wireless broadband (WiBro), high-speed downlink packet access (HSDPA), or high-speed uplink packet access (HSUPA). Similarly, the network connection may be over a personal area network such as Bluetooth or ultra wideband (UWB), or any combination of telecommunication technologies and protocols operable to establish a connection between the mobile device and the information processing system for the exchange of information. Once the optimal network connection has been established in step 220, determination of whether the mobile device or the information processing system will be responsible for information processing operations begins with step 222.

If the interface connection manager determines in step 206 that the mobile device is physically coupled to the information processing system, then the power state of the mobile device is determined in step 208. In one embodiment, the mobile device is physically coupled to the information management system through a dock. In another embodiment, the dock comprises a PCMCIA or ExpressCard slot. In other embodiments of the invention, the mobile device is physically coupled to the information processing system via a cable connection to an input/output (I/O) port. In one embodiment, the physical coupling is over a universal serial bus (USB) connection. In another embodiment, the physical coupling is over an IEEE 1394 (Firewire) connection.

The power state, along with other predetermined operational capabilities, and current operating status of the mobile device is then compared to the operational capabilities and operating status of the information processing system in step 210. It is then determined in step 212 whether a power management module implemented in the information processing system is operable to manage the power states of both the mobile device and the information processing system. If it is not, then determination of whether the mobile device or the information processing system will be responsible for information processing operations begins with step 222. Otherwise, it is then determined in step 214 whether the power management module will use the information processing system's power source to supply power to the mobile device. If it is not, then determination of whether the mobile device or the information processing system will be responsible for information processing operations begins with step 222. Otherwise, it is then determined in step 216 whether the power management module will use the information processing system's power source to recharge the mobile device's battery. If it is, then mobile device battery recharge operations begin in step 218. Otherwise, then determination of whether the mobile device or the information processing system will be responsible for information processing operations begins with step 222.

If it is determined in step 222 that the mobile device is going to be used to perform information processing operations, then it is determined in step 224 whether the mobile device will use the information processing system's peripherals to perform the operations. If not, then it is determined in step 234 whether the mobile device will use its own peripherals to perform information processing operations. If the mobile device's own peripherals are to be used, then the interface connection manager establishes connection with the mobile device's peripheral interfaces in step 236. Processing operations then begin in step 238 until it is determined in step 240 whether to change peripheral connections. If it is decided to change peripheral connections, then the process repeats itself beginning with step 224. If it is decided not to change peripherals, it is then determined in step 242 whether to change systems for information processing operations. If it is decided to change systems for information processing operations, the process repeats itself beginning with step 222. Otherwise, it is determined in step 244 whether the mobile device has been decoupled from the information processing system. If it has, operations stop in step 246. Otherwise, detection of the coupling of a mobile device continues, beginning with step 202.

If it is determined in step 224 that the mobile device will use the information processing system's peripherals to perform the processing operations, then it is determined in step 226 whether the information processing system is in a low power state. If the information processing system is in a low power state, then it is determined in step 228 whether to raise the information processing system to a high power state. In one embodiment of the invention, the power management module implemented in the information processing system raises the information processing system to a high power state in step 230. Once the information processing system has been raised to a high power state, then connections to the information handling system's peripheral interfaces are established in step 232 by the interface connection manager. It is then determined in step 234 whether the mobile device will also use its own peripherals to perform information processing operations. If the mobile device's own peripherals are to be used, then the interface connection manager establishes connection with the mobile device's peripheral interfaces in step 236. Processing operations then begin in step 238 until it is determined in step 240 whether to change peripheral connections. If it is decided to change peripheral connections, then the process repeats itself beginning with step 224. If it is decided not to change peripherals, it is then determined in step 242 whether to change systems for information processing operations. If it is decided to change systems for information processing operations, the process repeats itself beginning with step 222. Otherwise, it is determined in step 244 whether the mobile device has been decoupled from the information processing system. If it has, operations stop in step 246. Otherwise, detection of the coupling of a mobile device continues, beginning with step 202.

If it is determined in step 222 that the information processing system is going to be used instead of the mobile device to perform information processing operations, then it is determined in step 226 whether the information processing system is in a low power state. If the information processing system is in a low power state, then it is determined in step 228 whether to raise the information processing system to a high power state. In one embodiment of the invention, the power management module implemented in the information processing system raises the information processing system to a high power state in step 230. Once the information processing system has been raised to a high power state, then connections to the information handling system's peripheral interfaces are established in step 232 by the interface connection manager. It is then determined in step 234 whether the information processing system will also use the mobile device's peripherals to perform information processing operations. If the mobile device's peripherals are to be used, then the interface connection manager establishes connection with the mobile device's peripheral interfaces in step 236. Processing operations then begin in step 238 until it is determined in step 240 whether to change peripheral connections. If it is decided to change peripheral connections, then the process repeats itself beginning with step 224. If it is decided not to change peripherals, it is then determined in step 242 whether to change systems for information processing operations. If it is decided to change systems for information processing operations, the process repeats itself beginning with step 222. Otherwise, it is determined in step 244 whether the mobile device has been decoupled from the information processing system. If it has, operations stop in step 246. Otherwise, detection of the coupling of a mobile device continues, beginning with step 202.

If it is determined in step 226 that the information processing system is already in a high power state, or if it is determined in step 228 to not raise the information processing system to a high power state, then connections to the information handling system's peripheral interfaces are established in step 232 by the interface connection manager. It is then determined in step 234 whether the information processing system will also use the mobile device's peripherals to perform information processing operations. If the mobile device's peripherals are to be used, then the interface connection manager establishes connection with the mobile device's peripheral interfaces in step 236. Processing operations then begin in step 238 until it is determined in step 240 whether to change peripheral connections. If it is decided to change peripheral connections, then the process repeats itself beginning with step 224. If it is decided not to change peripherals, it is then determined in step 242 whether to change systems for information processing operations. If it is decided to change systems for information processing operations, the process repeats itself beginning with step 222. Otherwise, it is determined in step 244 whether the mobile device has been decoupled from the information processing system. If it has, operations stop in step 246. Otherwise detection of the coupling of a mobile device continues, beginning with step 202.

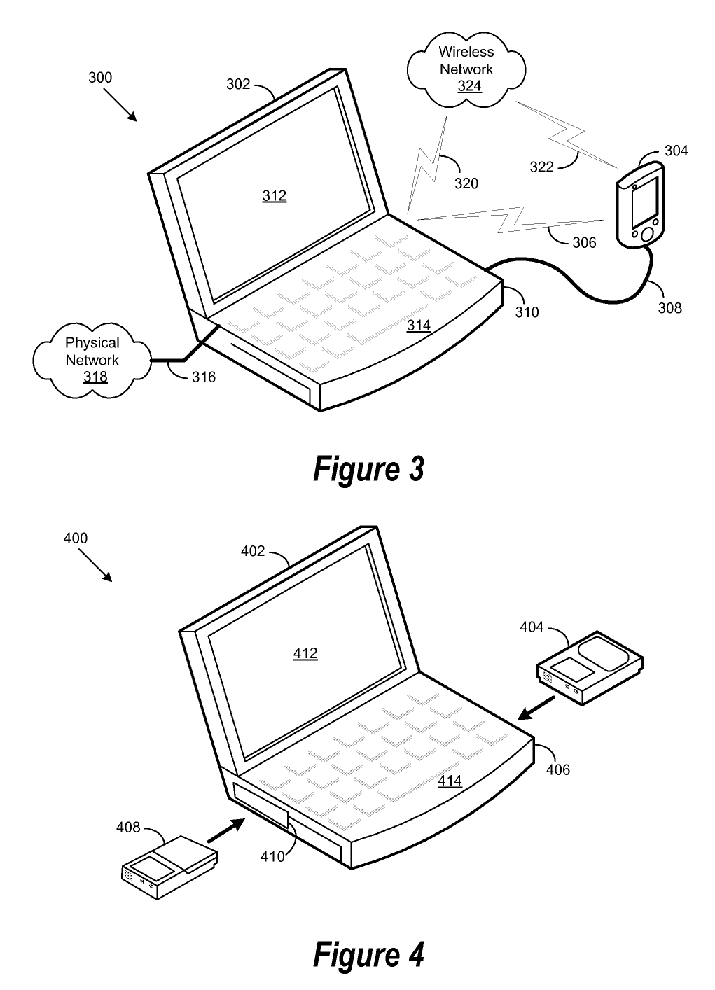

FIG. 3 is a generalized illustration of an information processing system 300 as coupled to a mobile device in accordance with an embodiment of the invention. In selected embodiments, coupling of mobile device 304 to information processing system 302 enables the mobile device 304 to access the information processing system's 302 peripherals, such as display screen 312 and keyboard 314. The coupling of the two systems also allows mobile device 304 to access physical network 318 and wireless network 324 through their respective connections to information processing system 302. In one embodiment, an interface connection manager (not shown) and a power management module (not shown) are implemented to enable information processing system 302 to remain in a low power state while mobile device 304 accesses its peripherals.

In different embodiments, mobile device 304 is physically coupled to information processing system 302 via physical cable 308 to an input/output (I/O) port 310. In one embodiment, mobile device 304 is physically coupled over a universal serial bus (USB) connection. In another embodiment, the physical coupling is over an IEEE 1394 (Firewire) connection. In still another embodiment, the physical coupling is over a PCI Express (PCIe) connection. In other embodiments, mobile device 304 is wirelessly coupled to information processing system 302 via a wireless connection 306 such as implemented in a personal area network (PAN). In one embodiment, the wireless connection is over a Bluetooth connection. In another embodiment, the wireless connection is over an ultra wideband (UWB) connection. In various embodiments, an interface connection manager (not shown) is implemented to determine the operational capabilities and operating status of information processing system 302 and mobile device 304. Their respective operational capabilities and status are compared and the interface connection manager selects the optimum communications channel connection between the two systems.

In these embodiments, the interface connection manager is also implemented in information processing system 302 to enable mobile device 304 to access networks 318, 324 supported by information handling system's 302 network connections 316, 320. Conversely, the interface connection manager is also implemented to enable the information processing system 302 to access networks 324 supported by the mobile device's 304 network connections 322. In one embodiment, mobile device 304 couples either physically 318 or wirelessly 306 to information handling system 302 to access physical network 318 over physical connection 316. In different embodiments, the physical network 318 may comprise a local area network (LAN) such as an Ethernet network or a wide area network (WAN) such as the Internet. In another embodiment, mobile device 304 couples either physically 308 or wirelessly 306 to information handling system 302 to access wireless network 324 over wireless connection 320. In a different embodiment, information processing system 302 physically couples 308 to mobile device 304 to access wireless network 324 over wireless connection 322. In this embodiment, physical connection 308 is over a USB connection and network 324 is an EDGE data network. It will be apparent to those of skill in the art that it is advantageous to have one system optimized for localized communications (e.g., Ethernet LAN, 802.11 WiFi for an information processing system) and another system optimized for roaming communications (e.g., GSM, EDGE for a mobile device). By coupling the two systems, they can each use the other's communication capabilities as appropriate and as needed, while maintaining a single user account for each service. As a result, the user experiences greater communications access flexibility while saving on communications costs and power consumption. For example, a user's information processing system can also receive subscription display services normally accessible only through their mobile device. These services could include voice telephony, text messages, instant messages, email, digital personal TV reception, digital rights management (DRM) media content, and personalized web channels available only through the mobile device's network carrier.

In various embodiments, wireless network 324 may comprise a wireless local area network (WLAN) such as a WLAN based on a variant of IEEE standard 802.11, or a wireless wide area network (WWAN) such as a WWAN based on enhanced data rates for GSM evolution (EDGE), wideband code division multiple access (W-CDMA), evolution-data optimized (EVDO), IEEE 802.16 (WiMAX), wireless broadband (WiBro), high-speed downlink packet access (HSDPA), and high-speed uplink packet access (HSUPA). In various embodiments, the interface connection manager is implemented to determine the operational capabilities and operating status of information processing system 302 and mobile device 304. Their respective operational capabilities and status are compared and the interface connection manager selects the optimum communications channel connection between the information processing system 302 and networks 318 and 324. Those of skill in the art will recognize that wireless network 324, physical network 318, physical connection 316, and wireless links 306, 320, 322 can comprise any combination of telecommunication technologies and protocols operable to establish a connection between two information processing systems for the exchange of information.

FIG. 4 is an illustration of an information processing system 400 as coupled to a mobile device through a plurality of docking connections in accordance with an embodiment of the invention. In selected embodiments, mobile devices 404, 408 are physically coupled to the information processing system 302 through a dock. Coupling of mobile devices 404, 408 to information processing system 302 enables the mobile device 308 to access the information processing system's 402 peripherals, such as display screen 412 and keyboard 414 as described in greater detail herein. The coupling of the two systems likewise allows information processing system 402 to access the communication connections and other capabilities of mobile devices 404 and 408 as described in greater detail herein.

In one embodiment, dock 406 is a receptacle to physically couple mobile device 404 to information processing system 302. In another embodiment, dock 410 is a PCMCIA or ExpressCard slot to physically couple mobile device 408. In yet another embodiment, mobile device 404 is docked in receptacle dock 406 and mobile device 408 is docked in PCMCIA or ExpressCard dock 410 concurrently, allowing a user to access both devices through information processing system 402. In this embodiment, an interface connection manager (not shown) enables the information processing system to similarly access the I/O peripherals and communication interfaces implemented by mobile devices 404 and 408. As an example, a user may transfer digital photographs from mobile device 408 to information processing system 410, where they are viewed on display 412 for editing. Once edited, they are then transferred to mobile device 408, which comprises a cellular data connection. While the mobile device 408 is still docked, the user uses the mobile device's 408 cellular connection to transmit the pictures to a recipient's cell phone.

In some embodiments, a power management module (not shown) is implemented to manage the power states of information processing system 302 and the mobile devices 404 and 408 when they are physically coupled via docks 406 and 410. In one embodiment, the power management module is implemented to provide power from information processing system 302 to mobile devices 404 and 408 when they are physically coupled via docks 406 and 410. In another embodiment, the power management module is implemented to manage the power state of the docked mobile devices 404 and 408 to a predetermined power state that is operable to recharge the docked mobile devices' 404 and 408 battery (not shown).

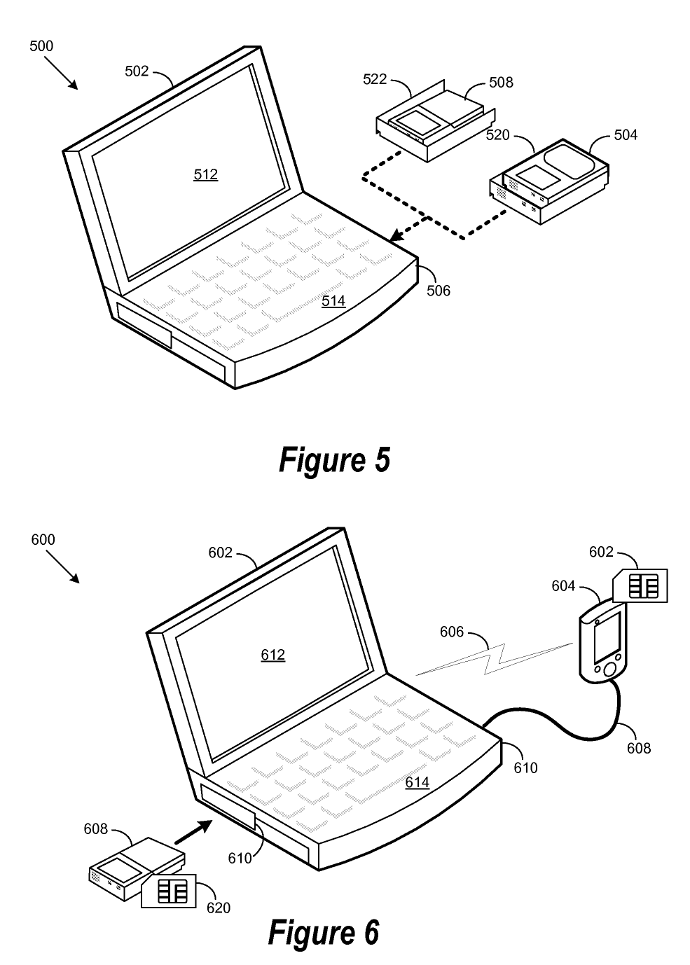

FIG. 5 is an illustration of an information processing system 500 enabled for coupling to a plurality of mobile devices through the implementation of a docking adapter in accordance with an embodiment of the invention. In selected embodiments, mobile devices 504 and 508 are physically coupled to the information processing system 502 through a universal dock 606. Universal dock adapters 520 and 522 respectively adapt mobile devices 504 and 508 for coupling with information processing system 502 through universal dock 506. In one embodiment, universal dock adapters 520 and 522 comprise physical and electrical connectors for conveying signals between mobile devices 504, 508 and information processing system 502. Coupling of mobile devices 504 and 508 to information processing system 502 enables the mobile device 308 to access the information processing system's 502 peripherals, such as display screen 512 and keyboard 514 as described in greater detail herein. The coupling of the two systems likewise allows information processing system 502 to access the communication connections and other capabilities of mobile devices 504 and 508 as described in greater detail herein.

FIG. 6 is a generalized illustration of an information processing system 600 enabled for coupling to a plurality of mobile devices comprising an authentication module as implemented in accordance with an embodiment of the invention. In selected embodiments, mobile devices 604 and 608 comprise an authentication module 620. Coupling of mobile devices 604 and 608 to information processing system 602 enables the mobile devices 604 and 608 to access the information processing system's 602 peripherals, such as display screen 612 and keyboard 614. In one embodiment, an interface connection manager (not shown) is implemented to enable information processing system 302 to communicate with the authentication modules 620 and perform authentication operations familiar to those of skill in the art. In one embodiment, authentication module 620 comprises a subscriber information module (SIM) card implemented to authenticate a user to information processing system 602. In another embodiment, authentication module 620 is implemented to authenticate a user to another information processing system over a network connection. In one embodiment, the mobile device 604, 608 does not comprise the authentication module 620. However, the mobile device 604, 608 is able to provide authentication services through information handling system 602 by extension of secure network services implemented by the mobile device's 604, 608 mobile carrier network. In one embodiment, the user accesses mobile device 604, 608 through information processing system 602 to connect to a network authentication server over a secure 3G wireless connection. Once connected, authentication operations are performed until the user is authenticated. In another embodiment, authentication module 620 is used to authenticate a user so they can access content protected through the use of digital rights management (DRM) mechanisms.

In different embodiments, mobile device 604 is physically coupled to information processing system 602 via physical cable 608 to an input/output (I/O) port 610 as described in greater detail herein. In other embodiments, mobile device 604 is wirelessly coupled to information processing system 602 via a wireless connection 606 such as implemented in a personal area network (PAN) as described in greater detail herein. In still other embodiments, mobile device 608 is physically coupled to information processing system 602 through PCMCIA or ExpressCard dock 610 as described in greater detail herein. In various embodiments, an interface connection manager (not shown) is implemented to determine the operational capabilities and operating status of information processing system 602 and mobile device 604 to perform authentication operations. Their respective operational capabilities and status are compared and the interface connection manager selects the optimum secure communications channel connection between the two systems. Once securely connected, authentication operations are performed.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for processing information, comprising:
a first information processing system operable to be coupled to a second information processing system;
processing logic to establish at least one communication channel operable to communicate information between said first and second information processing systems;
an interface connection bus operable to enable a plurality of interface connections between said first and second information processing systems; and
an interface connection manager operable to enable said second information processing system to perform information processing operations, wherein said second information processing system is connected to at least one input/output device interface of said first information processing system.

2. The system of claim 1, wherein said second information processing system is operable to be physically coupled to said first information processing system.

3. The system of claim 2, wherein said physical coupling is through a cable, said cable comprising a plurality of interface connections.

4. The system of claim 2, wherein said physical coupling is through a dock, said dock comprising a plurality of interface connections.

5. The system of claim 4, wherein said dock comprises a PCMCIA or ExpressCard slot, said PCMCIA slot comprising a plurality of interface connections.

6. The system of claim 4, wherein said dock comprises a receptacle, said receptacle configured to physically couple at least one said second information processing system comprising a predetermined form factor.

7. The system of claim 4, wherein said dock comprises a receptacle configured to receive an adapter, said adapter operable to adapt said receptacle to physically couple said second information processing system comprising a predetermined form factor.

8. The system of claim 1, wherein said second information processing system is operable to be wirelessly coupled to said first information processing system.

9. The system of claim 1, wherein said communication channel is operable to communicate information between said first and said second information processing systems.

10. The system of claim 1, wherein said communication channel is operable to communicate information from said first and said second information processing systems to a third information processing system.

11. The system of claim 1, wherein said communications channel comprises a network connection over a physical interface.

12. The system of claim 1, wherein said communications channel comprises a network connection over a wireless interface.

13. The system of claim 1, wherein said interface connection manager is operable to detect the coupling of said first and said second information processing systems.

14. The system of claim 13, wherein said interface connection manager is operable to determine the operational capabilities of said first and said second information processing systems upon said coupling.

15. The system of claim 14, wherein said interface connection manager is operable to determine the operational status of said operational capabilities.

16. The system of claim 15, wherein said interface connection manager uses said operational status to determine the optimal said communications channel connection to communicate information between said first and said second information processing systems.

17. The system of claim 15, wherein said interface connection manager uses said operational status to determine the optimal communication channel connection to communicate information from said first and said second information processing systems to a third information processing system.

18. The system of claim 13, wherein said coupling enables at least one power connection between said first and said second information processing systems when physically coupled.

19. The system of claim 1, wherein said first information processing system comprises a power manager operable to manage the power states of said first and said second information processing systems through said interface connection bus.

20. The system of claim 19, wherein said power manager is operable to provide power from said first information processing system to said second information processing system when said first and said second information processing systems are physically coupled.

21. The system of claim 20, wherein said predetermined power state is used to control charging of a battery operable to power said second information processing system when said first and said second information processing systems are not physically coupled.

22. The system of claim 13, wherein said coupling enables said second information processing system to connect to said I/O devices coupled to said first information processing system I/O device interfaces.

23. The system of claim 22, wherein said first information processing system does not perform information processing operations while said connection is active.

24. The system of claim 22, wherein said connection is operable to connect when said first information processing system is operating in a low power state.

25. The system of claim 13, wherein said coupling enables said first information processing system to connect to said I/O devices coupled to said second information processing system I/O device interfaces.

26. The system of claim 1, wherein said second information processing system comprises an authentication module operable to perform authentication operations.

27. The system of claim 26, wherein said authentication module comprises a subscriber identity module (SIM), said SIM comprising authentication information.

28. A method for processing information, comprising:
coupling a first information processing system to a second information processing system;
using processing logic to establish at least one communication channel operable to communicate information between said first and second information processing systems;
enabling a plurality of predetermined interface connections between said first and said second information processing systems over an interface connection bus; and
enabling said second information processing system to perform information processing operations by using an interface connection manager to connect at least one input/output device interface of said first information processing system to said second information processing system.

29. The method of claim 28, wherein said second information processing system is operable to be physically coupled to said first information processing system.

30. The method of claim 29, wherein said physical coupling is through a cable, said cable comprising a plurality of interface connections.

31. The method of claim 29, wherein said physical coupling is through a dock, said dock comprising a plurality of interface connections.

32. The method of claim 31, wherein said dock comprises a PCMCIA slot, said PCMCIA slot comprising a plurality of interface connections.

33. The method of claim 31, wherein said dock comprises a receptacle, said receptacle configured to physically couple at least one said second information processing system comprising a predetermined form factor.

34. The method of claim 31, wherein said dock comprises a receptacle configured to receive an adapter, said adapter operable to adapt said receptacle to physically couple said second information processing system comprising a predetermined form factor.

35. The method of claim 28, wherein said second information processing system is operable to be wirelessly coupled to said first information processing system.

36. The method of claim 28, wherein said communication channel is operable to communicate information between said first and said second information processing systems.

37. The method of claim 28, wherein said communication channel is operable to communicate information from said first and said second information processing systems to a third information processing system.

38. The method of claim 28, wherein said communications channel comprises a network connection over a physical interface.

39. The method of claim 28, wherein said communications channel comprises a network connection over a wireless interface.

40. The method of claim 28, wherein said interface connection manager is operable to detect the coupling of said first and said second information processing systems.

41. The method of claim 40, wherein said interface connection manager is operable to determine the operational capabilities of said first and said second information processing systems upon said coupling.

42. The method of claim 41, wherein said interface connection manager is operable to determine the operational status of said operational capabilities.

43. The method of claim 42, wherein said interface connection manager uses said operational status to determine the optimal said communications channel connection to communicate information between said first and said second information processing systems.

44. The method of claim 42, wherein said interface connection manager uses said operational status to determine the optimal communications channel connection to communicate information from said first and said second information processing systems to a third information processing system.

45. The method of claim 40, wherein said coupling enables at least one power connection between said first and said second information processing systems when physically coupled.

46. The method of claim 28, wherein said first information processing system comprises a power manager operable to manage the power states of said first and said second information processing systems through said interface connection bus.

47. The method of claim 46, wherein said power manager is operable to provide power from said first information processing system to said second information processing system when said first and said second information processing systems are physically coupled.

48. The method of claim 47, wherein said predetermined power state is used to control recharging of a battery, said battery operable to power said second information processing system when said first and said second information processing systems are not physically coupled.

49. The method of claim 40, wherein said coupling enables said second information processing system to connect to said I/O devices coupled to said first information processing system I/O device interfaces.

50. The method of claim 49, wherein said first information processing system does not perform information processing operations while said connection is active.

51. The method of claim 49, wherein said connection is operable to connect when said first information processing system is operating in a low power state.

52. The method of claim 40, wherein said coupling enables said first information processing system to connect to said I/O devices coupled to said second information processing system I/O device interfaces.

53. The method of claim 28, wherein said second information processing system comprises an authentication module operable to perform authentication operations.

54. The method of claim 53, wherein said authentication module comprises a subscriber identity module (SIM), said SIM comprising authentication information.
